(19) United States
(12) Patent Application Publication
(10) Pub. No.: US 2026/0349814 A1
(43) Pub. Date: Nov. 5, 2026

(54) Machine-Language Model Predicted Code Extension Parallel Executing

(71) Applicant: GDM Holding LLC, Mountain View, CA (US)

(72) Inventor: David Alexander Greene, Bloomfield, NJ (US)

(21) Appl. No.: 19/199,161

(22) Filed: May 5, 2025

(51) Int. Cl. G06F 9/50

(52) U.S. Cl. CPC G06F 9/5027

(57) ABSTRACT

An example method includes obtaining, by a computing system including one or more computing devices, a model output generated by a machine-learned model, where the model output can include a plurality of function calls associated with one or more tool extensions; and causing execution, by the computing system, two or more of the plurality of function calls in parallel, where causing execution of the two or more function calls in parallel comprises: executing, by the computing system, a first worker thread for implementing a first function call of the plurality of function calls; and prior to completion of the first worker thread, executing, by the computing system, a second worker thread for implementing a second function call of the plurality of function calls.

### FIELD

The present disclosure relates generally to machine learning processes and machine-learned devices and systems. More particularly, the present disclosure relates to improved management of machine-learned model predicted code extensions with parallel execution of the predicted code extensions.

### BACKGROUND

Machine-learned models interact with other programs by exchanging code of various types. Machine-learned models utilize vector databases of unstructured data and/or structured data to respond to input to the machine-learned models. Unstructured data is employed by machine-learned models to search for text relevant to input, using similarity measures. Structured data is utilized by machine-learned models to integrate capabilities into the machine-learned models for function calling.

Function calling capabilities enable machine-learned models to perform operations to invoke functions in programs. Machine-learned models enabled with function calling capabilities use text input to infer appropriate functions to run from available functions. The machine-learned models output necessary parameters for running functions. The machine-learned models output the parameters to programs that run the functions based on triggers in code used to run the functions. Large-language models (LLMs) interact with other machine-learned models to perform function calling based on extensions provided to the LLMs.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system that may include one or more computing devices, a model output generated by a machine-learned model, where the model output may include a plurality of function calls associated with one or more tool extensions. The method also includes causing, by the computing system, execution two or more of the plurality of function calls in parallel, where execution of the two or more function calls in parallel may include executing a first worker thread for implementing a first function call of the plurality of function calls; and prior to completion of the first worker thread, executing a second worker thread for implementing a second function call of the plurality of function calls.

The computer-implemented method where the model output may include a set of computer-executable programming language code, the set of computer-executable programming language code may include the plurality of function calls.

The computer-implemented method where executing the first worker thread for implementing the first function call may include transmitting, by the first worker thread, a first application programming interface (api) communication to a first tool extension of the one or more tool extensions; and execution of the two or more function calls in parallel may include executing the second worker thread for implementing the second function call prior to receipt, by the first worker thread, of a response to the first api communication from the first tool extension.

The computer-implemented method where executing the first worker thread for implementing the first function call may include generating, by the first worker thread, a future response object that serves as a placeholder for a result of implementing the first function call.

The computer-implemented method where execution of the two or more function calls in parallel may include maintaining one or more future response objects associated with one or more dependencies between two or more threads. The computer-implemented method may include receiving, by the computing system, two or more tool results from the two or more function calls; and the method further may include processing, by the computing system, the two or more tool results with the machine-learned model to generate an additional model output.

The computer-implemented method where the first worker thread may implement the first function call to receive a first tool result from a first tool extension; and the second worker thread may implement the second function call to receive a second tool result from a second, different tool extension.

The computer-implemented method where execution of the two or more function calls in parallel may include executing the first worker thread on a first processing node; and executing the second worker thread on a second processing node

The computer-implemented method where execution of the two or more function calls in parallel may include transmitting in response to execution of the first function call by the first worker thread, a first query to at least one database, and receiving a response to the first query; and transmitting in response to execution of the second function call by the second worker thread, a second query to at least one database, and receiving a response to the second query.

The computer-implemented method where each of the two or more of the plurality of function calls is a function call for an image processing task, where executing the first function call may include dispatching a request for a first image processing task and receiving following the dispatch of the request, results of the first image processing task, and where executing the second function call may include dispatching a request for a second image processing task and receiving following the dispatch of the request, results of the second image processing task.

The computer-implemented method where each of the two or more of the plurality of function calls may be a function call for an audio processing task, where executing the first function call may include dispatching a request for a first audio processing task and receiving following the dispatch of the request, results of the first audio processing task, and where executing the second function call may include dispatching a request for a second audio processing task and receiving following the dispatch of the request, results of the second audio processing task.

The computer-implemented method where each of the two or more of the plurality of function calls is a function call to a materials design tool for designing a physical material, where executing the first function call may include dispatching a request for a first material design task and receiving following the dispatch of the request, results of the first material design task, and where executing the second function call may include dispatching a request for a second material design task and receiving following the dispatch of the request, results of the second materials design task.

The computer-implemented method where each of the two or more of the plurality of function calls is a function call to at least one robot control tool for controlling a mechanical robot to perform a physical task, where executing the first function call may include dispatching a request for a first physical task and receiving following the dispatch of the request, results of the first physical task, and where executing the second function call may include dispatching a request for a second physical task and receiving following the dispatch of the request, results of the second physical task.

Example aspects of the present disclosure provide an example computing system that includes one or more processors; and one or more example non-transitory computer-readable media that collectively store an agent system configured to obtain a model output generated by a machine-learned model configured to generate a model output based on a model input, where the model output may include a plurality of function calls associated with one or more tool extensions; and cause execution of two or more of the plurality of function calls in parallel, where execution of the two or more function calls in parallel may include executing a first worker thread for implementing a first function call of the plurality of function calls; and prior to completion of the first worker thread, executing a second worker thread for implementing a second function call of the plurality of function calls.

The computing system where the model output may include a set of computer-executable programming language code, the set of computer-executable programming language code may include the plurality of function calls.

The computing system where executing the first worker thread for implementing the first function call may include transmitting, by the first worker thread, a first application programming interface (api) communication to a first tool extension of the one or more tool extensions; and execution of two or more of the plurality of function calls in parallel may include executing the second worker thread for implementing the second function call prior to receipt, by the first worker thread, of a response to the first api communication from the first tool extension.

The computing system where executing the first worker thread for implementing the first function call may include generating, by the first worker thread, a future response object that serves as a placeholder for a result of implementing the first function call.

The computing system where execution of the two or more function calls in parallel may include maintaining one or more future response objects associated with one or more dependencies between two or more threads.

The computing system where the agent system may be configured to receive two or more tool results from the two or more function calls; and process the two or more tool results with the machine-learned model to generate an additional model output.

Example aspects of the present disclosure provide one or more example non-transitory computer-readable media collectively storing instructions that, when executed by a computing system, cause the computing system to perform example operations. In some implementations, the example operations can include obtaining a model output generated by a machine-learned model, where the model output may include a plurality of function calls associated with one or more tool extensions; and causing execution of two or more of the plurality of function calls in parallel, where executing the two or more function calls in parallel may include executing a first worker thread for implementing a first function call of the plurality of function calls; and prior to completion of the first worker thread, executing a second worker thread for implementing a second function call of the plurality of function calls.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example block diagram depicting one or more systems managing function calls that are predicted by machine-learned models, associated with tool extensions and executed in parallel, according to example embodiments of the present disclosure.

FIG. 2 depicts an example block diagram depicting one or more systems utilizing a function call prediction-oriented machine-learned model and a task manager, according to example embodiments of the present disclosure.

FIG. 3 depicts an environment including one or more systems for managing predicted machine-learned model function calls in parallel, according to example embodiments of the present disclosure.

FIG. 4 is a flow chart diagram illustrating an example method for executing predicted machine-learned model function calls in parallel, according to example implementations of aspects of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Generally, the present disclosure is directed to computer-implemented systems and methods for parallel execution of function calls that are indicated in a machine-learned model output. For example, based on an input query, a machine-learned model can generate an output that indicates one or more function calls to be executed (e.g., to obtain data related to the query, to perform a task indicated by the query, etc.). For example, the output can include one or more function names and one or more input parameters for input to the function. In some implementations, one or more functions invoked by the model output may be executed in parallel to decrease a latency associated with processing the query.

In some implementations, a model may generate code as an intermediate step for processing a query. For example, the generated code may operate to retrieve information or perform computations and return the results to the model input for further processing. The generated code may invoke one or more functions exposed by one or more available tool APIs.

The generated code or the tool API code or both may be written using synchronous operations. For instance, synchronous code may be shorter and less complicated, which may be computationally cheaper and more reliable to generate with a model. However, executing independent operations in sequence (e.g., synchronously) may result in greater latency as compared to executing independent operations at least partially in parallel.

Advantageously, example implementations may obtain benefits of generating synchronous code while also obtaining the speedup of asynchronous execution. For instance, example implementations provide a technique for transforming synchronous function definitions into asynchronous functions. An example includes overriding a synchronous function definition using an asynchronous implementation of the function. The execution environment executing the original generated code from the model can import the transformed function with the override. Because of the override, when the original generated code invokes the function, the asynchronous version is executed within the execution environment. In this manner, for instance, the asynchronous nature of the actual execution may be invisible to the model generating the code (e.g., generating code based on the query, generating the API code).

In an example, the transformation from synchronous code to asynchronous code can include generating an asynchronous version of a function. The asynchronous version of the function can be implemented using a wrapper that invokes a non-blocking asynchronous task (e.g., attaching a task to an event loop, initiating an operation on a worker thread, initiating a process, etc.) to perform the original function. The wrapper can be defined in a portion of code generated by a model (e.g., the same or different model as generated the API code or the code based on the query).

The asynchronous version of the function can immediately return a placeholder or future object. This placeholder object can be propagated through the generated code (e.g., a result from one function may be passed to another as input). This propagation can be detected and used to identify dependent operations that are not executed in parallel. In some implementations, the original result from the function may be expected to provide various behavior (e.g., printing to stdout, having accessible attributes, etc.). In some implementations, one or more operations associated with the original response object may be added to the placeholder object so that the replacement is invisible to the invoking code.

In this manner, for instance, replacing the original function output with a placeholder can allow the function to be invoked using the original generated synchronous code output by the model, without blocking the execution of subsequent code. In this manner, for instance, execution of multiple functions in the generated code may be initiated without waiting for the response from the first initiated function.

In some implementations, operations in the generated synchronous code that operate on the original output of the function may involve blocking operations. For instance, in some examples an operation to print a value to stdout may block further execution even if applied on a placeholder object, because to output the value to stdout generally the value must first be obtained. This blocking behavior may limit the effectiveness of downstream synchronous to asynchronous transformations. In some implementations, example aspects of the present disclosure include overriding the blocking operation applied to the placeholder object with a non-blocking replacement. For example, a non-blocking print command can be defined that asynchronously accumulates the value into a buffer that can then be later written to stdout without blocking execution of subsequent portions of the generated code.

In some implementations, the order of returned values from function calls may be preserved (e.g., using queuing or a buffer structure) so that the final code output returned to the model after execution (e.g., a record of stdout) is effectively indistinguishable from the output of the generated code if executed synchronously. In this manner, for instance, the query processing model that emits the generated code and receives the output generated by execution of the code may achieve benefits of interacting in synchronous code while also achieving benefits of asynchronous execution.

Example implementations of the present disclosure can provide for a number of technical effects and benefits. Example implementations can achieve reduced latency by executing one or more operations in parallel. For example, serial execution of i/o-bound operations can involve significant idle periods simply waiting for a response from an external system or a slow operation on the same system. Parallel execution can decrease a cumulative time required to complete all tasks for processing a query.

Example implementations can achieve increased hardware efficiency by reducing periods of underutilization of resources. For example, idle processor capacity can consume power without returning a benefit (e.g., without furthering performance of a task). By leveraging parallelization, such as by performing some tasks while awaiting for API responses (e.g., in an event loop), or performing different tasks in different threads or on different processor cores, a given amount of resources may be utilized at a higher utilization rate, decreasing an amount of resources left idle.

Example implementations can achieve such benefits while also using one or more models to generate synchronous code. In some examples, synchronous code may be shorter than a natively asynchronous implementation of the same functionality. As such, synchronous code may provide a more compact, signal-rich input to a model (e.g., for instructing the model regarding available tools). Synchronous code may likewise provide a more compact output representation for computer-executable outputs, allowing models to generate code using smaller output representations. In some examples, such as with sequence processing models, smaller input sequences and smaller output sequences can result in smaller internal activation computations, smaller attention computations, smaller activation caches, fewer forward passes through the model, etc.

Smaller code representations can provide computational cost reductions at inference time and at training time. The example benefits described above may accrue any time the model executes a forward pass, either at training time or inference time. Additionally, training datasets may be smaller.

Further, such benefits may accrue for a model that generates code in response to a query and also for a model that generates tool code. For example, generated tool code may be less complex to validate against unit tests, which may also be generated by a model. For example, fewer unit tests may be required to validate a generated tool in synchronous code.

Additionally, generating an asynchronous wrapper definition may accrue further benefits over attempting to generate fully asynchronous code natively from the model. For example, factorizing the generation of synchronous and asynchronous code can allow for focused generation of wrapper functionality without complexities introduced by generating both tool logic and asynchronous logic together.

Additionally, constructing a synchronous-to-asynchronous transformation pipeline can enable the above improvements to flow even to code generation systems that were trained only on synchronous code without requiring further training. For example, training or re-training code generation models can be extremely resource-intensive. This computationally expensive training can be avoided by using a synchronous-to-asynchronous transformation pipeline to asynchronously execute synchronous code. In this manner, for example, existing code generation systems can be augmented to boost efficiency and reduce latency.

In these and other respects, example implementations can provide for more energy-efficient execution of operations using machine-learned models and code generated by such models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

In some embodiments, executing the two or more function calls in parallel includes receiving two or more tool results. The tool results include, for example, information retrieved from one or more databases in response to queries that are dispatched in response to execution of the function calls. The servicing of multiple queries in parallel results in an improvement in an information retrieval function for retrieving information from one or more databases.

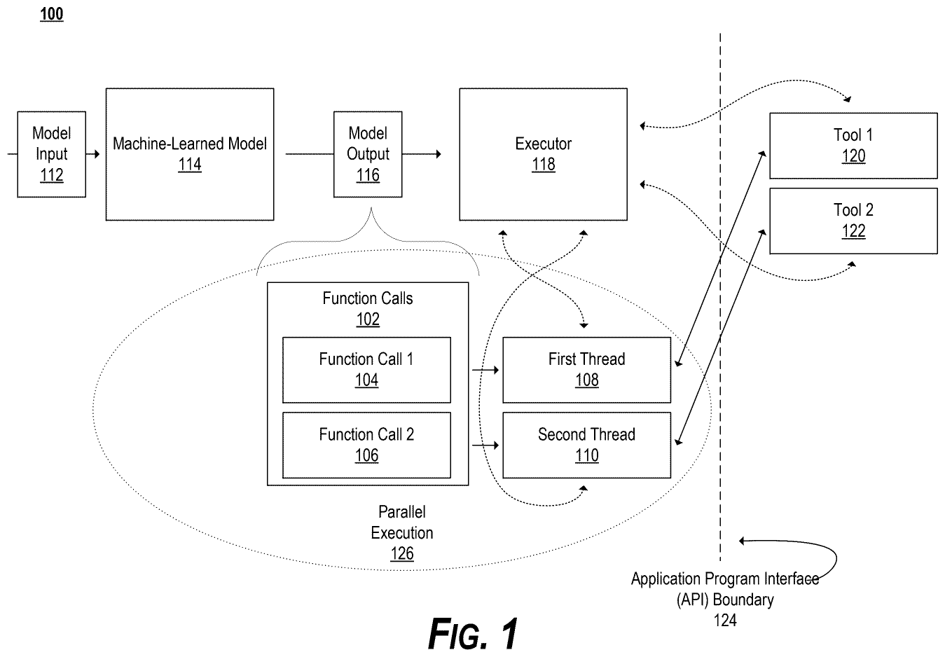

FIG. 1 depicts an example block diagram depicting one or more systems 100 managing function calls that are predicted by machine-learned models, associated with tool extensions and executed in parallel, according to example embodiments of the present disclosure. The system(s) 100 can be utilized to manage (e.g., in parallel) predicted function calls (also referred to herein simply as “function calls”) 102. The system(s) 100 can be utilized to parallelly manage (e.g., execute) the function calls 102.

Parallel machine-learned model-predicted function call execution can include parallel execution of the function calls 102. The function calls 102 can include various numbers, combinations, and/or types of function calls. In some examples, the function calls 102 can include a function call 104, a function call 106, one or more other function calls, or any combination thereof. Any combination of the function calls 102, such as the function call 104, the function call 106, and/or the other function call(s), can be executed in parallel. For example, the function call 106 (e.g., a subsequent function call, chronologically) can be executed prior to completion of the function call 104 (e.g., a previous function call, chronologically).

Parallel execution can be implemented using threads. For example, a first function call can be executed in a first thread and a second function call can be implemented in a second thread. The first thread can be implemented by a same or different core of a processor device as that which implemented the second thread. The first thread or the second thread may be a real or virtual thread.

Various threads of various numbers, combinations, and/or types, as discussed below in further detail, can be associated with the function calls 102. For example, a thread (also referred to herein as “first thread”) 108, a thread (also referred to herein as “second thread”) 110, and/or one or more other threads can be associated with the function call 104, the function call 106, the other function call(s), respectively.

Other parallelization methods may be used in some implementations. For example, some function calls may not be thread-safe. Some function calls may be implemented using asynchronous execution frameworks which initiate one or more tasks in an event loop and cycle through the event loop awaiting results from one or more long-running tasks. Multiple tasks may be initiated prior to receiving results from one or more of the tasks. For instance, initiating a task may not block the initiation of other tasks. The results from the tasks may be collected as they are received, allowing the operations associated with the tasks (e.g., waiting for a server response over a network) to be conducted at least partially concurrently. An event-loop based asynchronous execution framework may be used in lieu of or in combination with a multithreading approach.

In some implementations, multiple processes may be initiated on multiple real or virtualized processor cores. For example, a multiprocessing framework may be used to execute tasks at least partially in parallel by initiating a first function call on a first processing core and initiating a second function call on a second processing core (e.g., prior to completion of the first function call).

The system(s) 100 can perform parallel machine-learned model-predicted function call management (also referred to herein simply as “parallel management”) of the function calls 102. The function calls 102 can be associated with various numbers, combinations, and/or types of data, information, and/or operations associated with one or more machine-learned models.

The machine-learned model(s) can include a machine-learned model 114. For example, the function calls 102, such as a partial set or an entire set of all function calls being predicted (e.g., by the system(s) 100 and/or one or more other systems), can include predicted function calls. The function calls 102 can include predicted function calls being generated, based on model input (also referred to herein as “model input”) to the machine-learned model(s).

The machine-learned model 114 can manage (e.g., identify, determine, receive, obtain, retrieve, store, modify, delete, etc.) model input, which can include model input 112, in various ways. For example, the function calls 102 can include predicted function calls, based on model input 112 to the machine-learned model 114. The function calls 102 can include, and/or be included in, a partial set or an entire set of all function calls predicted by the system(s) 100.

The machine-learned-model 114 can manage (e.g., identify, determine, receive, obtain, retrieve, generate, store, modify, delete, etc.) output (also referred to herein as “model output”) 116. Model output 116 of the machine-learned-model 114 can include the function calls 102. The machine-learned model 114 can manage model output 116 based on model input 112. For example, the function calls 102 can be generated to be output, via model output 116, based on model input 112 to the machine-learned model 114.

The function calls 102 being predicted based on model input 112 can be included in model output 116, which can be processed utilizing parallel management. Parallel management can include, in particular, according to some instances, parallel execution of the function calls 102. The machine-learned model 114 can provide model output 116 in response to managing model input 112.

Management of model input can be performed by one or more artificial intelligence agents. In some examples, the artificial intelligence agent(s) can include an artificial intelligence agent. Management of model input can be performed by the artificial intelligence agent(s) (e.g., the artificial intelligence agent), which can include the machine-learned model(s) (e.g., the machine-learned model 114) and/or one or more tool use managers. For instance, the system(s) can manage, and/or be utilized to manage, the tool use manager(s), which can include one or more executors. In such an instance or another instance, the executor(s) can include an executor 118.

Parallel execution (e.g., of the function call(s)) can be performed by the executor 118 in various ways. Parallel execution (e.g., and possibly any other type of management) of the function calls 102 can be performed by the system(s) 100, such as by utilizing the executor 118. In some examples, the executor 118 can obtain model output 116, including the function calls 102, which can be associated with one or more API tools (also referred to herein simply as “tool(s)”). Model output 116 can include a set of computer-executable programming language code, which can include the function calls 102.

The tool(s) can be utilized for various purposes. Any of the tool(s), which can include a tool 1 (also referred to herein simply as “tool”) 120 and/or a tool 2 (also referred to herein simply as “tool”) 122, can be utilized to facilitate development, testing, monitoring, and/or management of one or more APIs. The tool(s) can include a partial set or an entire set of all API tools (e.g., all tools associated with the API(s)). For instance, the tool(s), with which one or more tool extensions (e.g., one or more different tool extensions) can be associated, such as the tool 120 and/or the tool 122, can be associated with the API(s) (e.g., an API), as represented in FIG. 1 by a dotted line depicting an API boundary 124 between the API (e.g., with which the tool 120 and the tool 122 are associated) and the artificial intelligence agent(s)/the machine-learned model(s).

The tool(s), and/or the tool extension(s) associated with the tool(s), of various types can be managed by the API(s). For example, individual ones of the tool extension(s), and/or individual groups of the tool extension(s), in the API can be associated with a corresponding tool of the tool(s) in the API. Any of the tool extension(s) can be utilized to inject, into the API, custom data, tailored to specific requirements, without altering an API specification. Any of the tool extension(s) can be utilized to add, to the API, one or more additional descriptive elements that may be utilized for consumers of the API. Any of the tool extension(s) can be supported by any of the API tool(s) and/or by various platforms. Any of the tool extension(s) can be utilized to enable various types of integrations and/or automations, such as one or more API gateways (e.g., one or more gateways associated with the API), one or more client software development kit (SDK) generators, one or more monitoring services, one or more other integrations/automations of various types, or any combination thereof.

Parallel management, such as parallel execution 126, performed by the system(s) 100 can include executing the worker threads in parallel. For example, the executor 118 can execute a worker thread (e.g., the thread 108) (or “first worker thread”) for implementing the function call 104 (or “first function call”) of the function calls 102 (e.g., plurality of function calls). In such an example or another example, the executor 118 can execute a worker thread (e.g., the thread 110) (or “second worker thread”) for implementing the function call 106 (or “second function call”) of the function calls 102.

Parallel management can include running tools and/or tool extensions in parallel. For example, any combination of the tool 120, the tool 122, and/or one or more other tools can be run in parallel. Alternatively or additionally, any combination of individual ones of one or more tool extensions associated with corresponding tools from among the tool 120, the tool 122, and/or one or more other tool extensions can be run in parallel.

The system(s) 100 can include various types of systems and/or devices utilized to control the executor 118. The system(s) 100 can include one or more systems utilized to manage the machine-learned model 114. Alternatively or additionally, the system(s) 100 can include one or more systems utilized to manage the executor 118. Alternatively or additionally, the system(s) 100 can include one or more systems utilized to manage the API.

The system(s) 100 can exchange various types of communications to control the API (e.g., the tool(s) and/or the tool extension(s) associated with the API). For example, the one or more communications utilized to control the tool 120, the tool 122, and/or the tool extension(s), can be exchanged. The communication(s) utilized to control the tool 120, the tool 122, and/or the tool extension(s), can be transmitted by the system(s) utilized to manage the executor 118 and received by the system(s) utilized to manage the API. The communication(s) utilized to control the tool 120, can include an API communication (or “first API communication”) (e.g., a transmission) transmitted to the tool 120 and/or a tool extension (or “first tool extension”) of the tool extension(s). The communication(s) utilized to control the tool 120, the tool 122 and/or the tool extension(s), can include an API communication (or “second API communication”) (e.g., a transmission) transmitted to the tool 122 and/or a tool extension (or “second tool extension”) of the tool extension(s).

The system(s) 100 can manage (e.g., execute) the worker thread(s), such as the thread 108 and/or the thread 110, in various ways based on whether one or more communications (e.g., responses) corresponding to, and/or associated with, the communication(s) (e.g., the transmission(s)) are received. For example, the system(s) 100 (e.g., the executor 118) can execute the thread 108. In such an example or another example, the system(s) 100 (e.g., the executor 118) can execute the thread 110 for implementing the function call 106 prior to receipt, by the thread 108, of a response to the first API communication, from the tool 120 and/or the first tool extension.

The worker thread(s) can be executed by the executor 118 in various ways and/or for various purposes. For example, the executor 118 can execute the thread 108 for implementing the function call 104, by generating, by the thread 108, a future response object that serves as a placeholder for a result of implementing the function call 104. In such an example or another example, the executor 118 can execute the function calls 102 in parallel by maintaining one or more future response objects associated with one or more dependencies between two or more threads. For instance, the executor 118 can execute the function calls 102 in parallel by maintaining one or more future response objects associated with the dependency(ies), such as one or more dependencies between the thread 108 and the thread 110.

Future response objects can implicitly create dependencies. In some examples, a future response object can create a dependency when the future response object is passed as an argument to a downstream function call. For example, in code that includes “result=flights.search(origin, destination)” and “best_hotel=hotels. search(result. date),” the hotels function call references the output of the flights function call; and a hotel thread may implicitly be blocked waiting for the flights result to become available. For instance, accessing the “date” attribute of the “result” object may invoke a method that blocks completion of hotels. search until the result is obtained and the date value delivered to the caller.

Various results from the function calls 102 can be utilized to manage the thread(s) in various ways to generate various occurrences of additional model output. For example, the executor 118 can execute the function calls 104 and 106 in parallel, which can include receiving one or more results from the function calls 104 and 106. The result(s) can include one or more results (or “tool result(s)”), from the tools 120 and 122 and/or the tool extensions. The system(s) 100 can process the tool result(s) with the machine-learned model 114 to generate additional model output. The system(s) 100 may generate a final output based on the tool result(s). The system(s) 100 may generate the final output by processing the tool results(s) with the machine-learning model 114 to generate the additional model output as discussed or may process the tool result(s) in another way, e.g. in a rule based way or using another model to generate the final output. The final output may be output to a user interface.

In some embodiments, the model input 112 and the final output each take the form of textual inputs. For example, the model input 112 may represent a textual query that is processed by the system(s) to obtain relevant tool results(s), which are used to provide a textual response to a user.

In some embodiments, the model output 116 may include image data. In this case, the software tools may include one or more image processing tools, e.g. tools that are specialized for processing a particular, or different particular types of images. Some examples can be images of the natural environment or of particular types of natural environment, images of urban scenes or types of urban scene, astronomical images, medical images or particular types of medical image, and so forth. The function calls 102 of model output 116 can each define an image processing task performed on pixels of a still or moving image; and the responses to the function calls, i.e. tool results, can define a result of the image processing task. The image processing task can be, e.g. an image classification task in which pixels of a still or moving image are processed to generate a response that categorizes a content of the image; or an object detection task in which the image is processed to generate a response that locates coordinates, e.g. bounding box coordinates, of one or more objects or types of object in the image; or an instance detection task in which the image is processed to generate a response that identifies the shapes of one or more objects or types of object in the image.

In some embodiments, the model output 116 may include audio data. In this case, the software tools 120, 122 may include one or more audio processing tools, e.g. tools that are specialized for processing a particular, or different particular types of audio data. For example, one type of software tool may be specialized for identifying performing speech-to-text conversion for speech in a particular language. The function calls 102 of model output 116 can each define an audio processing task performed on a set of audio data; and the responses to the function calls, i.e. tool results, can define a result of the audio processing data. The processing of audio data may include performing speech-to-text conversion.

The software tools can include one or more materials design tools for designing a physical material. Some examples include a protein design tool (e.g. an AlphaFold-related tool), a retrosynthesis tool (such as described in WO2021/263238), or a materials design tool. The function calls can each correspond to a query defining a materials design task performed, e.g. specifying one or more desired characteristics of the material; and the response to the function calls, i.e. the tool result, can define a result of the materials design task. Afterwards the material can be physically made (synthesized), e.g. for testing.

The software tools can include one or more robot control tools for controlling a mechanical robot to perform a physical task. The function calls can each correspond to a query defining a physical task to be performed by the robot; the response to the query can define a result of the physical task, e.g. it may include one or more observations of a result of the task, i.e. observations captured from the real world that have been returned as an output from the tool and that characterize a result of the physical task (which may be a synthesized material in the case of the preceding example).

Various results from the function calls 102 can be utilized to manage the thread(s) in various ways to generate various occurrences of additional model output. For example, the executor 118 can execute the function calls 102 and 104 in parallel, which can include receiving one or more results from the function calls 102 and 104. The result(s) can include one or more results (or “tool result(s)”), from the tools 120 and 122 and/or the tool extensions. The system(s) 100 can process the tool result(s) with the machine-learned model 114 to generate additional model output.

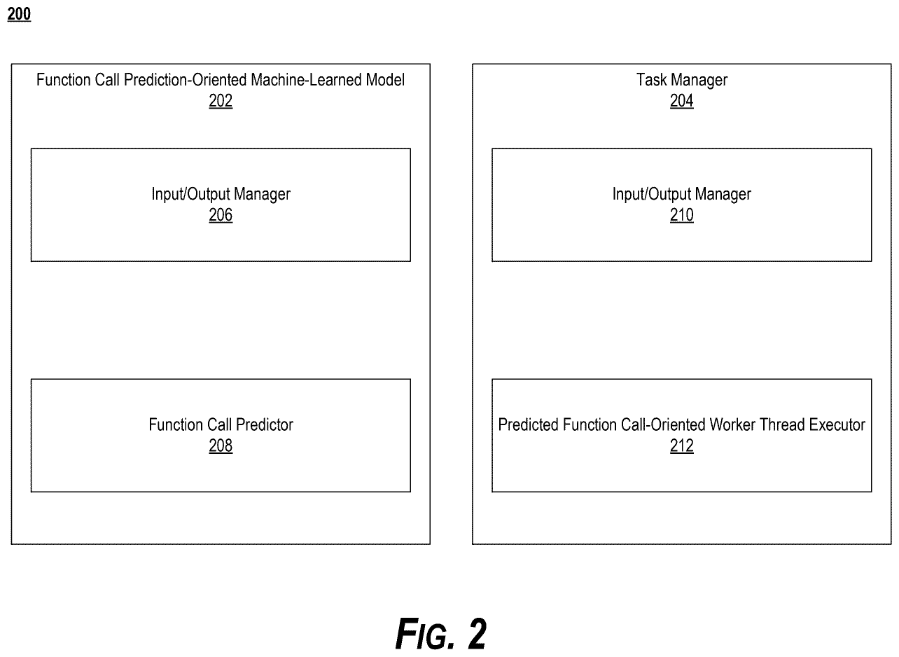

FIG. 2 depicts an example block diagram depicting one or more systems 200 utilizing a function call prediction-oriented machine-learned model and a task manager, according to example embodiments of the present disclosure. In some examples, any of the system(s) 200 can be implemented by, and/or utilized to implement, any of the system(s) 100. In those or other examples, the function call prediction-oriented machine-learned model, such as a function call prediction-oriented machine-learned model (also referred to herein simply as “machine-learned model” or “model”) 202, can be implemented by, and/or utilized to implement, the machine-learned model 114, as discussed above with reference to FIG. 1. In those or other examples, the task manager, such as a task manager 204, can be implemented by, and/or utilized to implement, the executor 118, as discussed above with reference to FIG. 1. The task manager 204 can include, and/or be communicatively coupled with, one or more APIs (e.g., the API(s), as discussed above with reference to FIG. 2).

The machine-learned model 202 and/or the task manager 204 can be utilized in various ways to execute predicted function calls in parallel. The machine-learned model 202 can include an input/output manager 206 enabling the machine-learned model 202 to be communicatively coupled to the task manager 204. The machine-learned model 202 can include a function call predictor 208 utilized to predict a plurality predicted function calls (e.g., function calls 102). The task manager 204 can include an input/output manager 206 enabling task manager 204 to be communicatively coupled to the machine-learned model 202. One or more communications can be exchanged between the machine-learned model 202 and the task manager 204 utilizing the input/output manager 206 and/or the input/output manager 210, respectively. The task manager 204 can include a predicted function call-oriented worker thread executor 212. Alternatively or additionally to the task manager 204 being implemented by, and/or utilized to implement, the executor 118, the executor 212 can be implemented by, and/or utilized to implement, the executor 118.

The task manager 204 can be managed in various ways. In some examples, the system(s) 200 can include one or more machine-learned models (e.g., the task-oriented machine-learned model(s)) associated with, and/or utilized to manage, the task manager 204. For instance, one or more systems in the system(s) 200 can be utilized to manage the task-oriented machine-learned model(s). In such an instance or another instance, the system(s) utilized to manage the task-oriented machine-learned model(s) can be utilized to manage the task manager 204. Alternatively or additionally, some or all of the system(s) utilized to manage the task manager 204 can be the same as, or different from, some or all of the system(s) utilized to manage the task-oriented machine-learned model(s).

Various types of output (e.g., of the machine-learned model 202) can include code utilized to parallelly execute function calls predicted by the machine-learned model 202. For example, output (e.g., the model output 116) can be generated, and/or provided, based on, code (or “API related code”) identified, and/or utilized, by the machine-learned model 202. In various cases, API related code can be prepended to model output, such as output by the machine-learned model 202 that is generated based on, and/or generated utilizing, model generated code (e.g., the example code (2), as discussed below in further detail). API related code can be associated with, and/or utilized to parallelly execute, various predicted function calls, and can include a generated API (e.g., and/or code associated therewith), such as example code, as follows:
@dataclasses.dataclass (1)
class SearchResult:
   origin_name: str |None=None
   destination_name: str |None=None
   prices: list[str] |None=None
class Flights:
   def search(
      origin: str
      destination: str,
   (->SearchResult |str:
      return [flights API impl.]
   flights-Flights( ).

Various types of API related code can be managed and/or utilized by the machine-learned model 202. For example, API related code, such as example code (1), can be shown, and/or available, to the machine-learned model 202. In some instances, API related code can include code utilized by the API (e.g., for one or more requests (or “service request(s)”) to a service). The request(s) can be related to various services, and can include various types of requests, such as one or more flight requests, one or more hotel requests, one or more ticket requests, one or more purchase requests, etc., or any combination thereof. The task manager 204 (e.g., the executor 212) can extract tool code (e.g., API tool code) out of any of one or more responses (e.g., output) generated by the machine-learned model 202. In some examples, the machine-learned model 202 can be shown only headers. In those or other examples, the machine-learned model 202 can generate code calling one or more headers, without having to predict all code required for parallel execution of function calls.

The task manager 204 (e.g., the executor 212) can exchange various API-related communications. In some examples, task manager 204 (e.g., the executor 212) can exchange one or more communications with an API from among the API(s). For instance, instead of making a call to the API and obtaining a corresponding result that is returned, a future response object can be returned from the API to the executor 212. In such an instance or another instance, an object can be given back to the executor 212; and code executed by the executor 212 does not have to wait for other code (e.g., work) to complete. Code associated with two or more function calls can be executed in parallel. So, because the object is returned, the executor 212 can continue, while executing a function call (e.g., the function call 104, as discussed above with reference to FIG. 1), to make a next function call (e.g., the function call 106, as discussed above with reference to FIG. 1). The executor 212 can accumulate one or more objects (e.g., utilizing, for instance, a parent thread) while work is still happening in the background in one or more child threads.

Various types of output provided by the machine-learned model 202 can be generated based on model generated code associated with predicted function calls. Predicted function calls can be executed in parallel by the task manager 204 utilizing model generated code (e.g., code that can be generated by a model and that can be utilized to invoke an API). Output provided by the machine-learned model 202 can be provided based on model generated code, which can be utilized to parallelly execute predicted function calls. Model generated code (e.g., including, and/or being generated based on, predicted function calls) can be utilized to invoke the API, and can include example code, as follows:
import flights (2)
result1=flights.search(“EWR”, “BWI”)
#Print entire response
Print(result1)
result2=flight.search(“JFK”, “BWI”)
#Access specific response field
print(result2.prices[0])

Output provided by the machine-learned model 202 can be generated based on various types of code utilized to execute function calls in parallel. For instance, output provided by the machine-learned model 202 can include API related code (e.g., the example code (1) and/or any other API related code) and model generated code (e.g., the example code (2) and/or any other model generated code) utilized to execute function calls in parallel. In some examples, asynchronous implementation of function calls can be executed in parallel by utilizing code (or “asynchronous function implementation code”), such as example code, as follows:
import sys (3)
OUTPUT=[]
def print(output: Any)->None:
   OUTPUT.append(output)
try:
   #START_CODE_BLOCK
   #The top 5 most intelligent dog breeds are Border Collie, Poodle
   #German Shepherd, Golden Retriever, and Doberman Pinscher according to #google search.
   breed=[‘Border Collie’, ‘Poodle’, ‘German Shepherd’, ‘Golden Retriever’, ‘Doberman Pinscher’]
   #I need to search for playlists of each breed.
   for breed in breeds:
      print(youtube.search(query=breed, result_type=‘PLAYLIST’))
   #END_CODE_BLOCK
finally:
   #Print accumulated output in the order it was generated.
   #
   #Exceptions from code execution are allowed to propagate, mirroring the
   #current contract
   #
   #Note that Future results can also package exceptions from the tools
   #themselves
   #Once these are accessed, the exception will be raised from within the final
   #block and similarly propagated to
   For output in OUTPUT:
      sys.stdout.write(f“{output}/n”).

In some examples, the implicit call in example code (3) to future_result._str_( ) can block on the result. The implicit call to future_result._str_( ) can be deferred until an end of code execution, allowing parallel processing of each fanout request.

Asynchronous output in example code (3) can be controlled to prevent errors due to the output being asynchronous. To prevent the model 202 from mistakenly attributing a response to a wrong API request, the asynchronous output may mirror (e.g., and, in some cases, exactly mirror) output from synchronous execution. For instance, although code output (e.g., both stdout+stderr) can be fed back into the model 202 along with the original generated code, the async output mirroring output from synchronous execution allows the asynchronous execution of the code to be invisible to the model, such that the model may remain in-domain (e.g., if it is trained to emit and ingest synchronous code and results, respectively).

The asynchronous output can be controlled to mirror output from synchronous execution based on various aspects of the system(s) 200. For instance, system(s) 200 can buffer output and then print the output in its original order, independent of when future response objects are completed. With asynchronous processing, code execution can continue beyond where a synchronous approach would otherwise fail-fast (e.g., due to an exception).

Various errors can be prevented with the mirrored output. Such errors being prevented can fall into two error classes, such as a class of errors associated with tool errors. For instance, output that may otherwise be flushed in its original order can be avoided. Such errors, resulting in any exceptions from earlier tool remote procedure calls (RPCs) being raised, thereby causing output to short-circuit before later tool responses (e.g., which would not have executed synchronously) are printed, can be avoided. Accordingly, the tool responses that may otherwise be hidden from the model 202 can be identified.

The errors being prevented that can fall into two error classes can include a class of errors associated with code errors. For instance, exceptions raised during code execution (e.g., an index out-of-bounds error), that may otherwise immediately short-circuit code execution from the main thread, preventing later tool RPCs from being scheduled, can be avoided. Errors due to previous responses that remain pending and have an opportunity to flush to stdout due to the use of a try/finally block, resulting in the original code exception being re-raised once the final block completes, can be prevented.

Various errors that may otherwise occur due to non-overridable operators can be prevented. While code such as “print(tool. operation(params))” can be parallelized by deferring the print operation (e.g., and therefore access to the future result), a block that may otherwise be placed on early field access (e.g., “print(tool.operation(params).field)”) can be avoided using a class override. For instance, the class override can be utilized in example code, as follows:
future_result=flights.search(dest=“SFO”) (4)
if future_result is not None:
   . . .

By utilizing a class override in code (e.g., the example code (4)), problems (e.g., a type of a result object not being returned) that may otherwise occur because of the “is” operator, in some cases, not being overridable, can be prevented. The problems can be prevented by utilizing the model 202 to predict the code (e.g., example code (4)), and wrapping future “None” responses in a container Dataclass. The code (e.g., example code (4)) can be re-written as “if not isinstance(future_result, type(None))” to override the class method, and to ensure that the type of the result object is returned.

Extensions may have world-mutating operations. Various types of code may include code, such as in example code, as follows, that may be prone to race conditions:
timers.create_timer(duration=“10 s”) (5)
print(timers.show_timers( ))

Code (e.g., example code (5)) may be prone to race conditions, depending on whether or not the timer object is created before the read operation is executed. In some examples, to enable dynamic mutating operations, a global list of active future response objects can be maintained. For instance, with examples in which dynamic mutating operations may be enabled, when a mutating operation is called (e.g., identified via a decorator in the tool manifest), all active future response objects can be identified and utilized to execute a mutating operation synchronously. The mutating operation can be executed synchronously at a tool-level (e.g. without affecting mutating timer actions by asynchronous hotels operations), or executed globally across all tools, depending on supported. Once the mutating operation has been completed, downstream RPCs can be allowed to continue asynchronously.

Risks of denial of service attacks can be mitigated in various ways. In some examples, risks of denial of service attacks can be mitigated by placing a limit (e.g., a hard limit) on the number of extension RPCs that can be sent for a single request. Alternatively or additionally, outgoing RPCs from a single user can be rate limited. Alternatively or additionally, a global executor can use a restricted threadpool size (e.g., 8 initially, and/or any other size) limiting the number of concurrent requests that can be made.

In some cases, asynchronous functionality can be disabled for various operations. For example, operation-level decorators can be provided in manifest definitions to disable parallel processing when various operations are invoked. Alternatively or additionally, for various asynchronous operations, future responses can be registered in a global list. Alternatively or additionally, when various operations, such as an operation with asynchronous functionality being disabled are encountered, relevant code can be modified to block on all previously registered future response objects, to enable the operation with asynchronous functionality being disabled to be executed synchronously. After the operation completes, code can continue execution, allowing code to again be executed in parallel.

In alternative or additional examples to disabling asynchronous operations globally across all tools, within-tool blocking can be utilized to handle scenarios in various types of code, such as in example code, shown below, that may include operations relying on state.
#Mutating operation. Must complete before showing all timers. (6)
timers.update_timer(label=“chicken”, new_duration=“10 m”)
google.search(“how do timers work”)
youtube.search(“how do timers work”)
print(timers.show_timers( ))

Code with within-tool blocking can be utilized in various ways. In some examples, a second operation-level decorator can be utilized to only disable parallel processing amongst operations within a current tool. A scope of the disabling can be expanded or shrunk (e.g., to include a cross-tool scope, a subset of tool operations scope, etc.).

With respect to within-tool blocking, mutating operations can be handled in various ways. When a mutating operation is encountered, a future response can be registered in a global list per tool, such as via code that includes “{[tool_name]->[list of pending Futures]}”. The future response can be registered in a global, per-tool list of mutating operations only, to block on all pending futures for this tool. Execution can wait within the future response object for the operation, so as to not block the main thread. (e.g., a snapshot of the global list of pending future response objects can be taken from the main thread, before updating with this new future). In some cases, within-tool blocking can be utilized in various types of code, such as in example code, as follows:
#Within-tool blocking example (7)
#timers.update_timer is registered as a mutating operation, and will not run
#asynchronously with other timer operations.
#
#Track all futures, now partitioned by tool (or any collection)
all_futures: dict[str, list[Future]]
#Track pending, world-mutating futures by tool. Only one will be executing at a
#time, but for simplicity we can append to a list.
mutating_futures: dict[str, list[Future]]
   #Operation 1->fut1
#1. Register as a pending future.
#2. Within thread, check to see if there are mutating futures to block on (none)
print(timers.show_timers( ))
#Updated state:
#all_futures: {“timers”: [fut1]}
#mutating_futures: {}
#Running: fut1
   #Operation 2->fut2
#1. Register as a pending future.
#2. Within thread, check to see if there are mutating futures to block on (none)
print(google.search(“how do timers work”))
#Updated state:
#all_futures: {“timers”: [fut1], “google”: [fut2]}
#mutating_futures: {}
#Running: fut1, fut2

### #Operation 3->Fut3

#1. Register as a pending future.
#2. Register as a pending mutating future
#3. Block on all pending futures for the current tool ([fut1]), within own thread
timers.update_timer(label=“chicken”, new_duration=“10 m”)
#Updated state:
#all_futures: {“timers”: [fut1, fut3], “google”: [fut2]}
#mutating_futures: {“timers”: [fut3]}
#Running: fut1, fut2
#Waiting:
#-fut3: [fut1]
   #Operation 4->fut4
#1. Register as a pending future.
#2. Check to see if there are mutating futures to block on (none)
print(youtube.search(“videos on how timers work”)
#Updated state:
#all_futures: {“timers”: [fut1, fut3], “google”: [fut2], “youtube”: [fut4]}
#mutating_futures: {“timers”: [fut3]}
#Running: fut1, fut2, fut4
#Waiting:
#-fut3: [fut1]
   #Operation 5->fut5
#1. Register as a pending future.
#2. Block on all pending mutating futures ([fut3]), within own thread
print(timers.show_timers( ))
#Updated state:
#all_futures: {“timers”: [fut1, fut3, fut5], “google”: [fut2], “youtube”: [fut4]}
#mutating_futures: {“timers”: [fut3]}
#Running: fut1, fut2, fut4
#Waiting:
#-fut3: [fut1]
#-fut5: [fut3]
[ . . . time goes by]
#Next state:
#all_futures: {“timers”: [fut1, fut3, fut5], “google”: [fut2], “youtube”: [fut4]}
#mutating_futures: {“timers”: [fut3]}
#Completed: fut1, fut2, fut4
#Running: fut3
#Waiting:
#-fut5: [fut3]
[. . . time goes by]
#Next state:
#all_futures: {“timers”: [fut1, fut3, fut5], “google”: [fut2], “youtube”: [fut4]}
#mutating_futures: {“timers”: [fut3]}
#Completed: fut1, fut2, fut4, fut3
#Running: fut5

Function calls can be executed in parallel utilizing the task manager 204, such as by utilizing the executor 212 and/or various types of input code. Code (or “executor input code”) utilized for asynchronous implementation of function calls can be submitted to the task manager 204 (e.g., the executor 212), based on various other code (e.g., one or more of the example codes (1), (2), and/or (3), and/or possibly one or more of example codes (4)-(7)). Executor input code (e.g., utilized for asynchronous implementation of function calls) submitted to the task manager 204, can include example code, as follows:
#Note the worker pool of the global executor can be used to limit (8)
#concurrent RPCs
EXECUTOR=concurrent.futures. ThreadPoolExecutor(max_workers=8)
#Primary API. Mirrors flight search, but wraps the response in the new
#FutureResult impl
#which delays blocking until first access.
def search(destination: str, origin: str)->FutureResponse[SearchResult |str]:
future_result=EXECUTOR.submit(flights.search, destination, origin)
return FutureResponse[SearchResult |str](future_result=future_result)

By utilizing code (e.g., one or more of the example codes (1), (2), and/or (3), and/or possibly one or more of example codes (4)-(7)), as discussed above, any executor input code (e.g., the example code (8)) submitted to the executor 212 can be the same as code submitted to, and serially executed by, any other executor of any of various existing systems. However, in contrast to conventional technology, by utilizing code according to the techniques discussed herein, such as by utilizing one or more of the example codes (1), (2), and/or (3), and/or possibly one or more of example codes (4)-(7), as discussed above, any executor input code submitted to the executor 212 can be utilized to execute predicted function calls (e.g., for invoking API tools during execution of the worker threads) in parallel. By way of example, “print(search_result)” can be supported by overriding “_str_API”. In such an example or another example, field access (e.g., “search_result_origin”) can be supported by overriding “_getattr_.” Additional operators can be overridden if necessary.

By utilizing various types of code (e.g., one or more of the example codes (1), (2), (3), and/or (8), and/or possibly one or more of example codes (4)-(7)), as discussed above, output by the machine-learned model 202 to parallelly execute function calls can be simple. For example, output by the machine-learned model 202 including, and/or based on, code (e.g., one or more of the example codes (1), (2), (3), and/or (8), and/or possibly one or more of example codes (4)-(7)), as discussed above, can include code (or “response wrapper code”), such as example code, as follows:
T=TypeVar(‘T’) (9)
class FutureResponse:
   def_ _init_ _(self, future_result: concurrent.futures.Future[T]):
   self._future_result=future_result
#Needed for print(response)
Def_ _str_ _(self)->str:
   return str(self._future_result.result( ))
#Needed for field access e.g., search_result.origin_name
def_ _getattr_ _(self, field: str)->Any:
   return getattr(self. _future_result.result( ), field)
#Needed for accessing dict/list response types e.g., results[0]
def_ _getitem_ _(self, key)->Any:
   return self._future_result.result( )[key]
#Needed for len(results)
def_ _len_ _(self)->int:
   return len(self._future_result.result( ))
#Needed for “if [result]:”
#
#Note that this does not handle “if [result] is not None”, which will always
#evaluate to true since the result is a Future object.
def_ _bool_ _(self)->bool:
   return bool(self._future_result.result( ))
#Needed for Union return types i.e. “if instanceof(result, T)”
@property
def_ _class_ _(self):
   return type(self._future_result. result( ))

Various types of code can be utilized to enable parallel execution of predicted function calls. In some instances, code utilized to enable parallel execution of predicted function calls can include various types of response wrapper code, such as example code (9); and possibly also various types of executor input code, such as example code (8). For example, the response wrapper code can be utilized to delay access to a parent thread by utilizing child threads, as discussed below in further detail. In such an example or another example, the response wrapper code can be utilized to delay access to the parent thread by utilizing blocking. Blocking can be utilized to allow the function calls to be executed asynchronously.

The executor 212 can identify function calls to determine whether function calls can be executed in parallel. For example, the executor 212 can identify, for any function calls (e.g., function calls for flight reservations) without dependencies, that the function calls without dependencies can be executed in parallel. Alternatively or additionally, the executor 212 can identify, for other types of function calls (e.g., function calls for a flight reservation and a hotel reservation) with dependencies, that the function calls with dependencies cannot be executed in parallel (e.g., a response from the function call for the hotel reservation that depends on a response of the function call for the flight reservation).

The executor 212 can parallelly execute predicted function calls (e.g., such as function calls without dependencies) by utilizing parent and child threads in various ways. For example, the executor 212, while executing instructions to make a function call (e.g., a call to a search service), can create a child thread. The child thread can be utilized to make an outbound call and can be paused. While the child thread (or “first child thread”) (e.g., the thread 108, as discussed above with reference to FIG. 1) is paused, the executor 212 can identify that another thread (or “second child thread”) (e.g., the thread 110, as discussed above with reference to FIG. 1) does not depend on any result from the first child thread. The executor 212 can continue, from a line of code where a previous outbound call (e.g., the function call 104, as discussed above with reference to FIG. 1, with which the thread 108 is associated) is made, to proceed to a next call (e.g., the function call 106, as discussed above with reference to FIG. 1, with which the thread 110 is associated). The executor 212 can create the other child thread (e.g., the thread 110) and continue on. The executor 212 can wait until a parent thread (e.g., a thread utilized to manage the threads 108 and 11) is executed to the very end of the code. The executor 212 can finally call a function (e.g., sys.stdout.write of example code (3), to print out all the results of the child threads.

By way of a hypothetical example, a parent thread for predicted function calls can cause a first child thread to be executed, followed by a second child thread being executed prior to completing the first child thread. The parent thread can wait and later return to the first child thread and ask for the result. As such, the call for the first child thread can be a blocking call, so that when the block happens, the first child thread pauses and is no longer executing on the CPU. Some signals, flags, etc., or any combination thereof, identified when child threads complete can be utilized by the parent thread to resume. The same process can repeat for subsequent child threads. Unlike in conventional technology where functions calls are completed in order, all outbound calls (e.g., without dependencies) according to the techniques discussed herein can be sent in parallel with one another because the parent thread (e.g., utilized to create the blocking/waiting call) can continue to send out the outbound calls.

By way of the hypothetical example or another hypothetical example, various default behaviors of various functions/function calls can be overridden. Instead of calling a default print (e.g., that generates a string), an override (e.g., an override of the_str_ API) can be added to change behavior of a print being called to not generate a string. The string can be added to a buffer when available. Blocking (e.g., during a print) on a response when calling an API (e.g., the_str_( ) API), which may otherwise prevent parallel execution, can be avoided by wrapping (e.g., such as in example code (3)) the generated code block with an overridden print( ) implementation that accumulates output, deferring access until the end of execution when writing to stdout. The print (e.g., being used to call two strings, such as to create a textual representation, and being used to call result to block and wait for work in child threads to complete) can just buffer the strings. Then, at the end of code execution (e.g., at the end of execution of asynchronous function implementation code, such as example code (3)), the buffer can be flushed to make all blocking/waiting calls to create texting representations for everything (e.g., for results of two function calls) and write that out. This enables the original order of results that would have been printed to be maintained, while also enabling parallel execution of the function calls.

By way of the hypothetical example or another hypothetical example, a task manager can be utilized to parallelly execute function calls by managing various code libraries in various ways. The task manager can utilize output from a machine-learned model, which may predict the same code and/or type of code utilized in existing systems (e.g., with capabilities to serially execute function calls). In contrast to existing systems, the task manager operating according to techniques discussed herein can execute calls to services in parallel. However, when there is a call to execute code, libraries of existing systems the code would otherwise reference can be swapped out with libraries implemented according to techniques discussed herein so that the code is immediately parallelized behind the scenes, without the machine-learned model (e.g., the machine-learned model predicting function calls) needing to know about the function calls being executed in parallel instead of serially. As a result, latency of execution of the function calls is significantly improved, without requiring the machine-learned model to make relatively complex predictions. In addition to reducing complexity, amounts of tokens needed to be decoded from machine-learned models can be reduced, enabling direct monetary costs and latency values to be reduced. Compute and time required for each token prediction can be reduced.

In the hypothetical example, parallel execution of predicted function calls can be performed with relatively simple and straightforward predictions made by the machine-learned model. Predictions from the machine-learned model come back the same way as if they were to be executed in serial. In other words, latency is reduced but complexity is hidden from the machine-learned model. The machine-learned model not needing to predict code for parallel execution of predicted function calls may be simpler and less prone to error.

By way of the hypothetical example or another hypothetical example, function calls that may be otherwise executed serially according to conventional technology can be executed in parallel. Machine-learned model predicted function calls, such as print(google_search(query=“query 1”)) and print(google_search(query=“query 2”)), can be executed parallelly. By not executing the predicted function calls linearly, a linear increase to an end-to-end latency (or “e2e latency”) can be prevented. Instead, the e2e latency of execution of the predicted function calls can be significantly improved by performing predicted function call parallel execution according to the techniques discussed herein. The e2e latency can be reduced to a maximum length of a single API call (e.g., while hiding complexity from the implementation of the machine-learned model), which can reduce error rates in model-generated code.

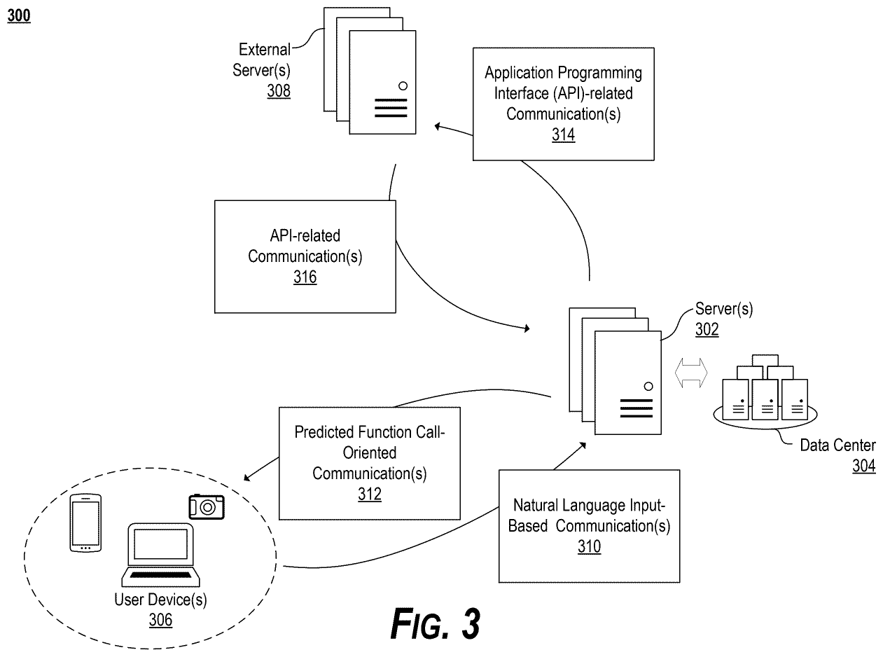

FIG. 3 depicts an environment including one or more systems 300 for managing predicted machine-learned model function calls in parallel, according to example embodiments of the present disclosure. The system(s) 100 can be implemented by, and/or utilized to implement, the system(s) 100 and/or 200, as discussed above with reference to FIGS. 1 and 2.

The system(s) 300 can include one or more servers 302, and one or more data centers 304 communicatively coupled to the server(s) 302. The server(s) 302 and/or the data center(s) 304 can manage, and/or be utilized to manage, one or more machine-learned models (e.g., the machine-learned model(s) 114 and/or 202, as discussed above with reference to FIGS. 1 and 2).

The system(s) 300 can include one or more devices (or “user device(s)”) 306 associated with one or more users. The user device(s) 306 can manage, and/or be utilized to manage, one or more executors (e.g., the executor 118, as discussed above with reference to FIG. 1) and/or one or more task managers (e.g., the task manager 204, as discussed above with reference to FIG. 2).

The system(s) 300 can include one or more servers (also referred to herein, for convenience and ease of explanation, as “external server(s)”) 308. Individual ones of the external server(s) 308 can be managed by a same service provider as the server(s) 302 and/or a different service provider from the server(s) 302; and/or individual ones of the server(s) 302 can be managed by a same service provider as the server(s) 302 and/or a different service provider from the external server(s) 308. In various cases, individual ones of the external server(s) 308 can be utilized to manage individual ones of one or more APIs (e.g., any of the API(s), as discussed above with reference to FIGS. 1 and 2, or any combination thereof).

Various communications can be exchanged between the server(s) 302 and the user device(s) 306. One or more communications (or “natural language-based communication(s)”) can be transmitted by the user device(s) 306 and to the server(s) 302 based on one or more natural language communications managed (e.g., identified, determined, received, obtained, retrieved, modified, deleted, stored, etc.) by the user device(s) 306. In some examples, the natural language-based communication(s) (also referred to herein simply as “communication(s)”) 310 can be managed (e.g., identified, determined, generated, triggered, modified, deleted, stored, etc.) based on the natural language communication(s), such as one or more prompts, one or more queries, one or more commands, one or more other communications of other types, or any combinations thereof, received from any of the user(s).

The natural language-based communication(s) 310 can be managed based on various types of content associated with, and/or identified via, the natural language communication(s). For example, the content can be associated with one or more services of various types, such as one or more flight requests, one or more hotel requests, one or more ticket requests, one or more purchase requests, one or more other services, or any combination thereof.

One or more communications (or “predicted function call-oriented communication(s)”) can be transmitted by the server(s) 302 and to the user device(s) 306 based on management of the natural language-based communication(s) 310. The predicted function call-oriented communication(s) (also referred to herein simply as “communication(s)”) 312 can be managed based on various types of content associated with, and/or identified via, the predicted function call-oriented communication(s) 310. Individual ones of, and/or individual groups of, the predicted function call-oriented communication(s) 310 can include one or more function calls, and/or content associated therewith. For example, at least one of the predicted function call-oriented communication(s) 312 can include function calls (e.g., the function calls 102, such as the function calls 104 and 106, as discussed above with reference to FIG. 1) to be executed in parallel. The function calls can be parallelly executed (e.g., executed in parallel, as discussed above with reference to FIGS. 1 and/or 2), such as by the user device(s) 306, and/or one or more other devices/servers/systems communicatively coupled thereto.

Various communications can be exchanged between the server(s) 302 and the server(s) 308. One or more communications (or “API-related communication(s)”) 314 can be transmitted by the server(s) 302 and to the server(s) 308 based on the communication(s) 310 and/or 312. In some examples, the API-related communication(s) 314 can be managed (e.g., identified, determined, generated, triggered, modified, deleted, stored, etc.) based on content associated with, included in, and/or generated based on, the communication(s) 310 and/or 312. In those or other examples, the API-related communication(s) 314 can be managed (e.g., identified, determined, generated, triggered, modified, deleted, stored, etc.) based on responses (e.g., response content) generated based on the communication(s) 310 and/or 312.

Various types of content can be included in the communication(s) 314. For example, the content can be utilized to execute the API(s), and/or code associated therewith. The content can be utilized to execute the API(s), and/or the associated code, based on the predicted function calls. In such an example or another example, the content can include content utilized to invoke one or more tools (e.g., the tools 120 and/or 122, as discussed above with reference to FIG. 1).

One or more communications (or “API-related communication(s)”) 316 can be transmitted by the server(s) 308 and to the server(s) 302. The API-related communication(s) (also referred to herein simply as “communication(s)”) 316 can be exchanged based on the communication(s) 310, 312, and/or 314. In some examples, the API-related communication(s) (also referred to herein simply as “communication(s)”) 316 can be managed (e.g., identified, determined, generated, triggered, modified, deleted, stored, etc.) based on content associated with, included in, and/or generated based on, the communication(s) 310, 312, and/or 314. In those or other examples, the API-related communication(s) 316 can be managed (e.g., identified, determined, generated, triggered, modified, deleted, stored, etc.) based on responses (e.g., response content) generated based on the communication(s) 310, 312, and/or 314.

Various types of content can be included in the communication(s) 316. For example, the content can be utilized to parallelly execute the predicted function calls, and/or code associated therewith. The content can be utilized to execute the predicted function calls, and/or the associated code, based on results of execution performed by the API(s). In such an example or another example, the content can be utilized to parallelly execute the predicted function calls based on results of invoking of the tools.

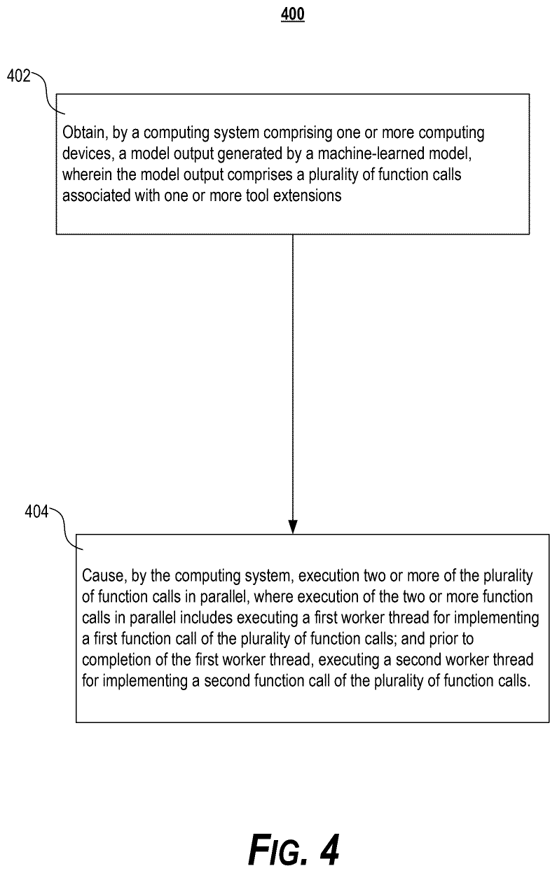

FIG. 4 is a flow chart diagram illustrating an example method 400 for executing predicted machine-learned model function calls in parallel, according to example implementations of aspects of the present disclosure. Although FIG. 4 depicts steps performed in particular orders for purposes of illustration and discussion, the methods of the present disclosure are not limited to the particularly illustrated orders or arrangements. The various steps of method 400 can be omitted, rearranged, combined, or adapted in various ways without deviating from the scope of the present disclosure. In some examples, the method 400 can be implemented utilizing the system(s) 100-300, as discussed above with reference to FIGS. 1-3, respectively.

At 402, the method 400 can include obtaining, by a computing system including one or more computing devices, a model output generated by a machine-learned model, the model output including a plurality of function calls associated with one or more tool extensions. In some examples, the model output (e.g., the model output 116, as discussed above with reference to FIG. 1) can be generated by the machine-learned model (e.g., the machine-learned model 114, as discussed above with reference to FIG. 1), based on model input (e.g., the model input 112, as discussed above with reference to FIG. 1).

At 404, the method 400 can include causing, by the computing system, execution two or more of the plurality of function calls in parallel, wherein execution of the two or more function calls in parallel includes executing a first worker thread for implementing a first function call of the plurality of function calls; and prior to completion of the first worker thread, executing a second worker thread for implementing a second function call of the plurality of function calls. The function calls (e.g., the function calls 102, as discussed above with reference to FIG. 1) can be executed in parallel by executing the first worker thread (e.g., the thread 108, as discussed above with reference to FIG. 1. The function calls (e.g., the function calls 102, as discussed above with reference to FIG. 1) can be executed in parallel based by executing the second worker thread (e.g., the thread 110, as discussed above with reference to FIG. 1) for implementing the second function call (e.g., the function call 106, as discussed above with reference to FIG. 1) of the plurality of function calls.

The method may be particularly adapted for implementation on one or more computing systems including parallel processing resources. For example, in some embodiments the computing system(s) include a first processing node for executing the first worker thread and a second processing node for executing the second worker thread. The first processing node and second processing node may each include separate processor cores of a processor. The parallel execution of function calls may be particularly advantageous in a parallel processing architecture in which distinct processing resources are available for executing the first worker thread and second worker thread.

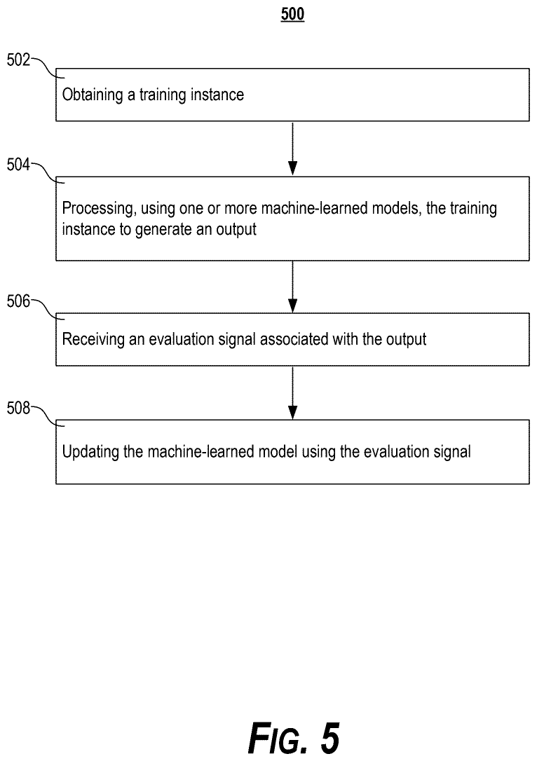

FIG. 5 depicts a flowchart of an example method 500 for training one or more machine-learned models according to aspects of the present disclosure. For instance, an example machine-learned model can include individual ones of the training machine-learned model(s), as discussed above with reference to FIGS. 1-3. In such an instance or another instance, the example machine-learned model, and/or another example machine-learned model, can include individual ones of the machine-learned model(s) (e.g., the trained machine-learned model(s)), such as the machine-learned sequence processing model(s), as discussed above with reference to FIGS. 1-3.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

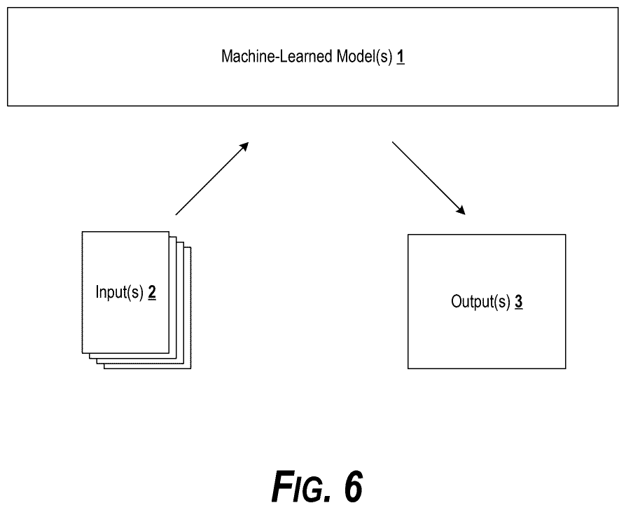

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the training machine-learned model(s), the trained machine-learned model(s) (e.g., partially and/or fully trained machine-learned model(s)), etc. Although various features, variations, and implementations described below are described with respect to machine-learned model(s) 1, it is to be understood that such features, variations, and implementations are to be understood as described with respect to each of the training machine-learned model(s), the trained machine-learned model(s) (e.g., partially and/or fully trained machine-learned model(s)), and/or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:1242.09368v2 (Oct. 14 1022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

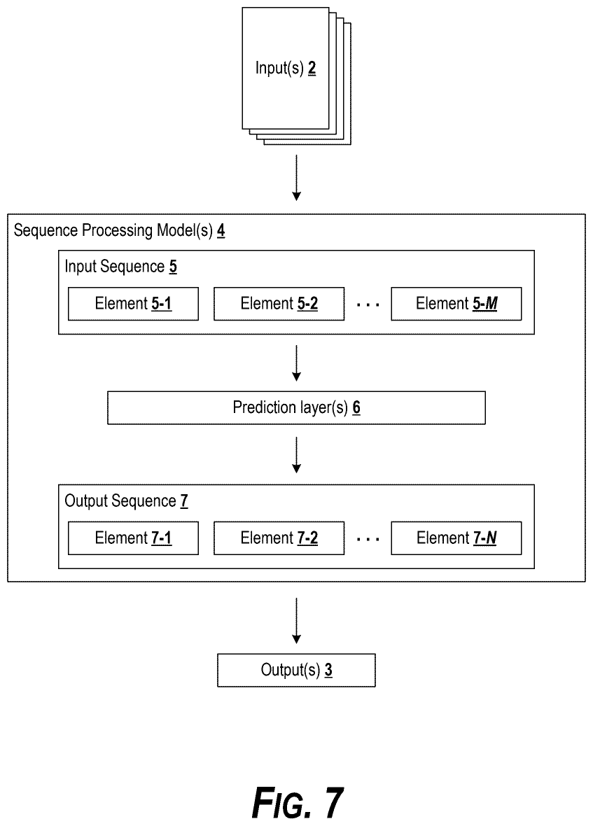

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Sequence processing models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https://arxiv.org/abs/2403.08295; Gemma 2: Improving Open Language Models at a Practical Size, Google, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/1244.14198; PaLI: A Jointly-Scaled Multilingual Language-Image Model, Google, https://arxiv.org/abs/1249.06794.

Sequence processing model(s) 4 can be multimodal. Example multimodal sequence processing models include, for instance, models described in Gemini: A Family of Highly Capable Multimodal Models, Google, https://arxiv.org/abs/2216.11805; Gemini 1.5: Unlocking multimodal understanding across millions of tokens of context, Google, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, arXiv:2010.11929v2 (Jun. 3, 1021), audio domains, see, e.g., Agostinelli et al., MusicLM: Generating Music From Text, arXiv:2301.11325v1 (Jan. 26, 1023), biochemical domains, see, e.g., Jumper et al., Highly accurate protein structure prediction with AlphaFold, 596 Nature 583 (Aug. 26, 1021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . 5-M depicted in FIG. 7 can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 1023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:1004.07437v3 (Nov. 16, 1020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

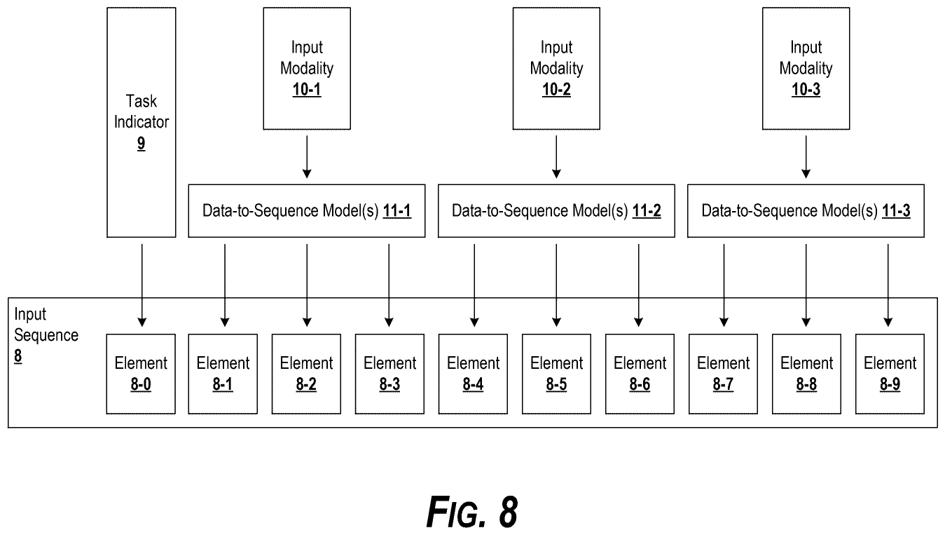

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

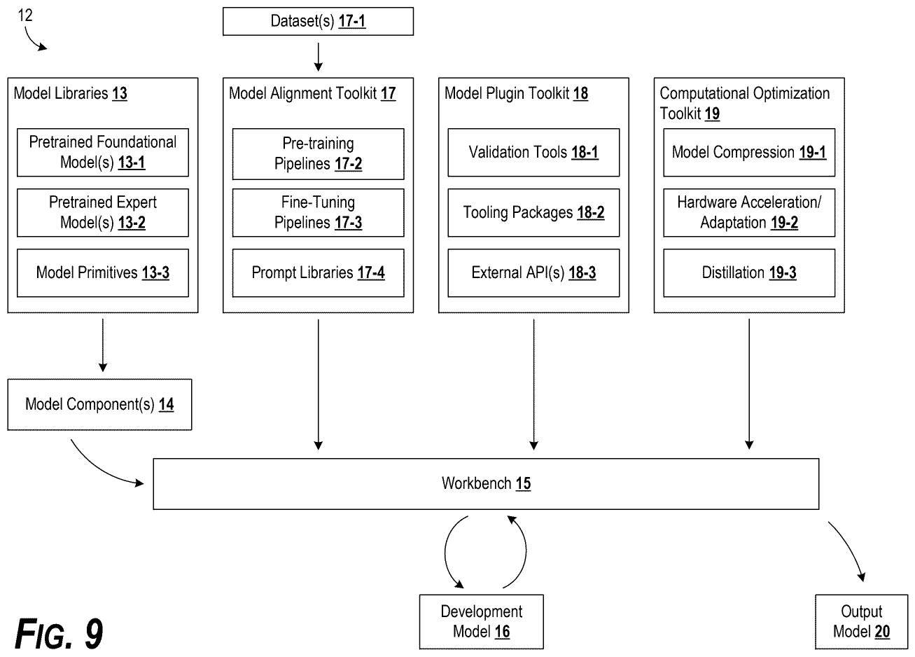

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

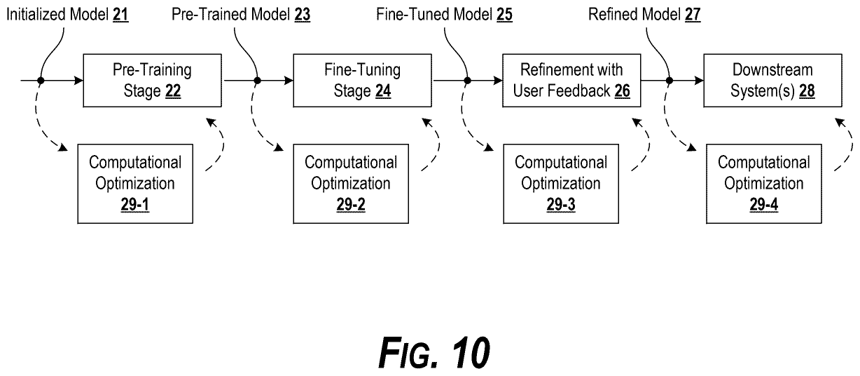

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

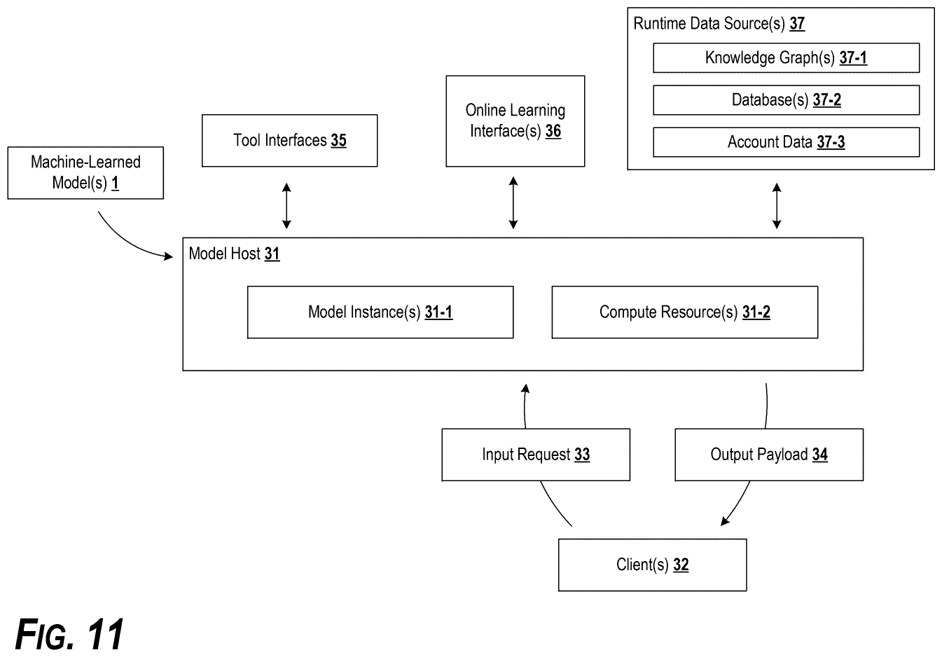

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate RLHF. Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

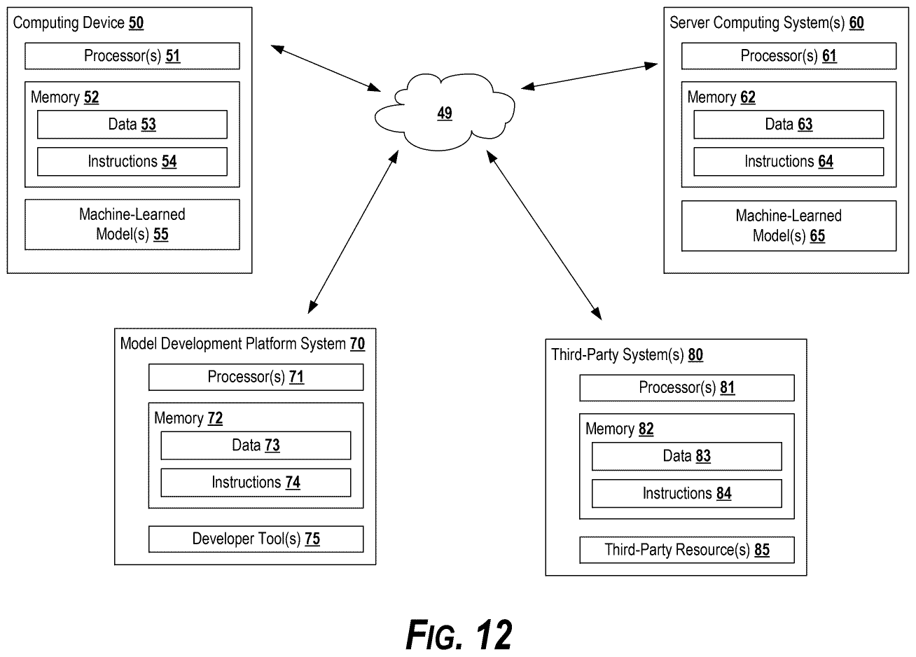

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

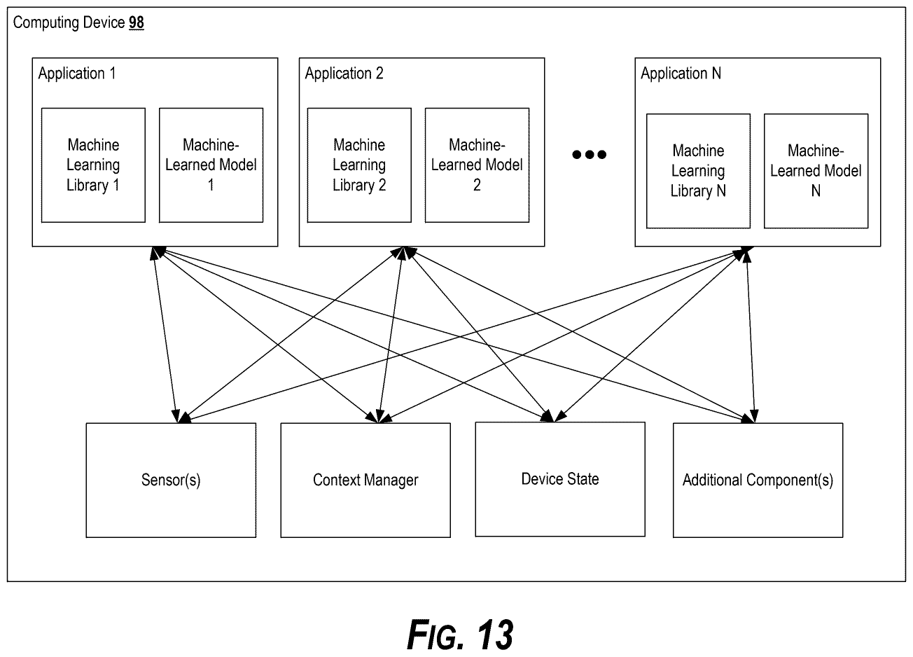

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

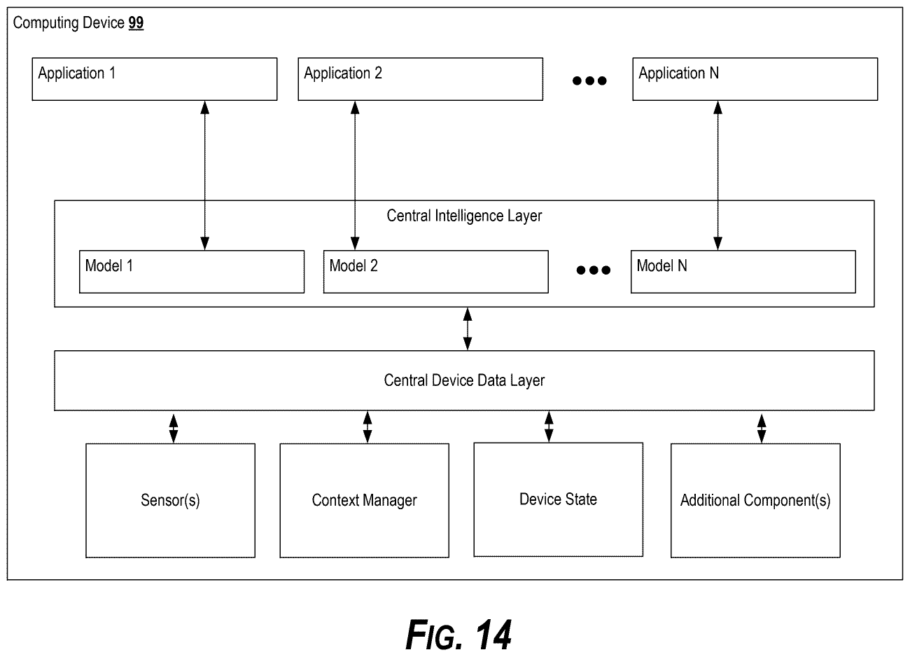

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in 16 18, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
obtaining, by a computing system comprising one or more computing devices, a model output generated by a machine-learned model, wherein the model output comprises a plurality of function calls associated with one or more tool extensions; and
causing, by the computing system, execution two or more of the plurality of function calls in parallel, wherein execution of the two or more function calls in parallel comprises:
executing a first worker thread for implementing a first function call of the plurality of function calls; and
prior to completion of the first worker thread, executing a second worker thread for implementing a second function call of the plurality of function calls.

2. The computer-implemented method of claim 1, wherein the model output comprises a set of computer-executable programming language code, the set of computer-executable programming language code comprising the plurality of function calls.

3. The computer-implemented method of claim 1, wherein:
executing the first worker thread for implementing the first function call comprises transmitting, by the first worker thread, a first application programming interface (API) communication to a first tool extension of the one or more tool extensions; and
execution of the two or more function calls in parallel comprises executing the second worker thread for implementing the second function call prior to receipt, by the first worker thread, of a response to the first API communication from the first tool extension.

4. The computer-implemented method of claim 1, wherein executing the first worker thread for implementing the first function call comprises generating, by the first worker thread, a future response object that serves as a placeholder for a result of implementing the first function call.

5. The computer-implemented method of claim 1, wherein execution of the two or more function calls in parallel comprises maintaining one or more future response objects associated with one or more dependencies between two or more threads.

6. The computer-implemented method of claim 1, comprising:
receiving, by the computing system, two or more tool results from the two or more function calls; and
the method further comprises processing, by the computing system, the two or more tool results with the machine-learned model to generate an additional model output.

7. The computer-implemented method of claim 1, wherein:
the first worker thread implements the first function call to receive a first tool result from a first tool extension; and
the second worker thread implements the second function call to receive a second tool result from a second, different tool extension.

8. The computer-implemented method of claim 1, wherein execution of the two or more function calls in parallel comprises:
executing the first worker thread on a first processing node; and
executing the second worker thread on a second processing node.

9. The computer-implemented method of claim 1, wherein execution of the two or more function calls in parallel comprises:
transmitting in response to execution of the first function call by the first worker thread, a first query to at least one database, and receiving a response to the first query; and
transmitting in response to execution of the second function call by the second worker thread, a second query to at least one database, and receiving a response to the second query.

10. The computer-implemented method of claim 1, wherein each of the two or more of the plurality of function calls is a function call for an image processing task,
wherein executing the first function call comprises dispatching a request for a first image processing task and receiving following the dispatch of the request, results of the first image processing task,
wherein executing the second function call comprises dispatching a request for a second image processing task and receiving following the dispatch of the request, results of the second image processing task.

11. The computer-implemented method of claim 1, wherein each of the two or more of the plurality of function calls is a function call for an audio processing task,
wherein executing the first function call comprises dispatching a request for a first audio processing task and receiving following the dispatch of the request, results of the first audio processing task,
wherein executing the second function call comprises dispatching a request for a second audio processing task and receiving following the dispatch of the request, results of the second audio processing task.

12. The computer-implemented method of claim 1, wherein each of the two or more of the plurality of function calls is a function call to a materials design tool for designing a physical material,
wherein executing the first function call comprises dispatching a request for a first material design task and receiving following the dispatch of the request, results of the first material design task,
wherein executing the second function call comprises dispatching a request for a second material design task and receiving following the dispatch of the request, results of the second materials design task.

13. The computer-implemented method of claim 1, wherein each of the two or more of the plurality of function calls is a function call to at least one robot control tool for controlling a mechanical robot to perform a physical task,
wherein executing the first function call comprises dispatching a request for a first physical task and receiving following the dispatch of the request, results of the first physical task,
wherein executing the second function call comprises dispatching a request for a second physical task and receiving following the dispatch of the request, results of the second physical task.

14. A computing system comprising:
one or more processors; and
one or more non-transitory computer-readable media storing:
an agent system configured to:
obtain a model output generated by a machine-learned model configured to generate a model output based on a model input, wherein the model output comprises a plurality of function calls associated with one or more tool extensions; and
cause execution of two or more of the plurality of function calls in parallel, wherein execution of the two or more function calls in parallel comprises:
executing a first worker thread for implementing a first function call of the plurality of function calls; and
prior to completion of the first worker thread, executing a second worker thread for implementing a second function call of the plurality of function calls.

15. The computing system of claim 14, wherein the model output comprises a set of computer-executable programming language code, the set of computer-executable programming language code comprising the plurality of function calls.

16. The computing system of claim 15, wherein:
executing the first worker thread for implementing the first function call comprises transmitting, by the first worker thread, a first application programming interface (API) communication to a first tool extension of the one or more tool extensions; and
execution of two or more of the plurality of function calls in parallel comprises executing the second worker thread for implementing the second function call prior to receipt, by the first worker thread, of a response to the first API communication from the first tool extension.

17. The computing system of claim 15, wherein executing the first worker thread for implementing the first function call comprises generating, by the first worker thread, a future response object that serves as a placeholder for a result of implementing the first function call.

18. The computing system of claim 15, wherein execution of the two or more function calls in parallel comprises maintaining one or more future response objects associated with one or more dependencies between two or more threads.

19. The computing system of claim 15, wherein the agent system is configured to:
receive two or more tool results from the two or more function calls; and
process the two or more tool results with the machine-learned model to generate an additional model output.

20. One or more non-transitory computer-readable media storing instructions that, when executed by a computing system, cause the computing system to perform operations, the operations comprising:
obtaining a model output generated by a machine-learned model, wherein the model output comprises a plurality of function calls associated with one or more tool extensions; and
causing execution of two or more of the plurality of function calls in parallel, wherein executing the two or more function calls in parallel comprises:
executing a first worker thread for implementing a first function call of the plurality of function calls; and
prior to completion of the first worker thread, executing a second worker thread for implementing a second function call of the plurality of function calls.
